(19) United States
(12) Patent Application Publication
(10) Pub. No.: US 2007/0058923 A1
(43) Pub. Date: Mar. 15, 2007

(54) Use of flash based memory to store and play feature length licensed movie or TV productions

(76) Inventor: Kirk A. Buhler, Corona, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/223,866

(22) Filed: Sep. 9, 2005

(51) Int. Cl. H04N 5/91

(52) U.S. Cl. 386/46

(57) ABSTRACT

The use of static or flash memory to store and play a full-length movie is disclosed. The flash or similar based static or recordable solid state memory is used in place of videotape or DVD disks. The full-length movies include licensed, commercial, copy written or proprietary creative moving pictures with sound. The use includes the recording, storage, and playing of the memory from a computer or custom play and or recording device that can record the information from a source and or play the recorded information. The use further includes using the memory for the rental and distribution of the movies on the memory module. The memory has the ability to store a complete licensed movie or TV production that can be stored, encoded, write protected, copy protected or re-written once or numerous times.

### FIELD OF THE INVENTION

This invention relates to using flash static memory devices to store and display feature length licensed movies and or TV productions. More particularly, the present invention relates a method of using static or flash-based memory media to record or store feature length, licensed or commercial movie or TV productions. The method further includes the use of static memory media for the sale, rental, and distribution of movies. The use also includes a displaying apparatus wherein the memory media can be installed and the movie played in the same manner that videotape and or DVD is currently used. The use further includes using the memory to store a complete movie that can be write protected, copy protected or re-written numerous times.

### BACKGROUND OF THE INVENTION

Movies were first created by connecting a number of still images together to create a moving image. These original movies were stores to long thin strips of plastic or celluloid. Today movies are created in a similar manner, but can be stored on magnetic tape or media such as VHS, beta and currently DVD disks. In all the formats that are available today, the stored image is moved past reading head to read the information that will later become shown as a movie. A 2-hour movie consists of about 151,200 images and audio. An average 2-hour movie can be stored on a 4.7 GB DVD or on 250 meters of videotape.

The use of non-volatile or flash-based drives has steadily increased both in terms of availability and storage capacity. They are currently being used to store still images in cameras, and to store sounds or music. In some cameras, the memory is used to store low resolution personal short movies. With the increased popularity of these drives, they are not being used to store licensed full-length movies. Playing and or recording devices such as Video tape and DVD players are not currently available to use of flash type removable memory for recording, storage, rental or sales of licensed full-length feature movies and alike because of the storage capacity and data transfer rate.

Two basic problems exist with using the flash-based memory devices that are available today. The first problem exists with the size of the memory modules that are available. With a standard DVD containing about 4.7 GB of storage, flash drive devices do not have the storage capacity to contain an equivalent movie. The second problem with currently available flash-based memory is that the data transfer rate for storing and playing movies is too slow to support them typical sustained data play rate of 39 mb per second.

U.S. Pat. No. 6,561,421 issued to Yu, U.S. Pat. No. 6,854,984 issued to Lee et al., and U.S. Pat. No. 6,717,817 issued to Lin et al. disclose various flash based memory cards and configurations that are designed for storing and reading data files, for use with computers, cameras, palm computers or other similar devices. None of them discloses using the memory devices for the storage and display of licensed media. They further are intended for the use by individuals or within companies, and do not suggest or imply the use of the flash memory for licensed sale, or rental, movies.

Japan patent number JP 10,154,180 issued to Sano Kenji, Kimura Hiroyuki, and Nagai Kiyuuichirou discloses a flash-based memory module combined with a DVD. The intent of this invention is to provide the DVD movie, with flash memory to store DVD movie rental information. This patent exemplifies many of the problems that the proposed application solves. Specifically the DVD is stored in a protective cover to prevent damage to the DVD. The use of the flash memory does not store the movie, but simply records information for the movie rental shop. It does not combine the rental movie from the DVD onto the flash-based memory that both simplifies the product and reduces the overall size of the product as disclosed in the proposed application.

What is needed is the use of removable flash type solid-state media for recording, storage, rental or sales of licensed full-length feature movies TV production and alike. The ideal use would further include a playing and or recording mechanism so this type of memory can be used with a home or theater television or monitor. The proposed process method and device provides this solution by providing simple components that can be used by a production studio, video rental store, video sales store, homeowner, or theater to provide the features disclosed in this application. The proposed device satisfies these needs.

### BRIEF SUMMARY OF THE INVENTION

It is an object of the present method of using static based flash drives to provide feature length licensed movies. The benefits of using this type of media to record, store and play movies exceed technologies that are currently available. Motors are completely eliminated in the transportation of the media. These motors are utilized in a VCR to load/eject a tape, and to drive the reels and capstan of the movie. Motors are utilized in DVD machine to move the reading head and spin the disk. The proposed solid-state movie storage system eliminates the need for the mechanical motors and mechanism to move the media past a reading head.

It is another object of the solid-state storage media to eliminate potential damage to the movie for all but the most destructive damage to the media that compromises the exterior and interior of the enclosure. Magnetic tape can be damaged by magnetic field and from touching the tape. A DVD is susceptible to damage caused by scratches on the disk.

It is another object of the flash solid-state storage media for movies to provide the storage in a package that is smaller in size than currently available movie packages. The storage device may take a variety of sizes and or shapes. Currently flash-based drives are known in a number of styles known as Compact Flash I, Compact Flash II, Smart Media, Memory Stick, Multimedia Card, Secure Digital (SD), Micro Drive, and XD Picture Card. These identify the most popular flash-based drives that are available, but the flash drive media may take a different configuration based upon design characteristics and requirements. Using a comparison of size a DVD is a disk about 120 mm in diameter and 1.4 mm in thickness. This is a total volume of about 16 cc. In contrast, the smallest flash memory measures 37 mm×45 mm×0.8 mm thick for a total volume of less than 1.33 cc. This flash-based memory is about 8% of the physical size of a DVD with an increase in the potential for storing additional information and is less susceptible to damage.

A further objective of using flash-based memory for movies is the increasing ability to provide flash memory with higher storage capacity. A DVD disk has a storage capacity of 4.7 GB of storage or 120 minutes. Flash drives have theoretically storage capacities far in excess of the 4.7 GB. Some movies where have a playing time of more than 120 minutes require multiple DVD's to play the entire movie. Newer dual layer DVD drives have a storage capacity of 8.5 GB. A Flash drive with capacity of 8 GB can show a movie of over 200 minutes and flash-based memory can show video of almost 7 hours. Today a number of TV shows make an entire season of shows available on multiple DVD's. A single 8 GB of flash memory could store an entire season with larger memory modules being capable of storing an even larger amount of video data. High resolution and wide screen movies may also require more memory than a DVD can store, but since the storage capacity of flash based memory can be increased without changing the connector, physical size or the playing device, Flash based memory is ideal for upwards compatible technology.

It is another object of the flash-based video storage to improve reliability of the playing device. Since there are no mechanical motors, the reliability is limited to the connectors and the electronic devices.

It is another object to utilize flash-based technology to increase the data storage and recall rates of flash based memory. The increased data transfer rates will allow data into and out of flash-based memory to occur at a faster rate and allow for an improvement in efficiency.

It is another object of utilizing flash-based memory for licensed movie products to provide encryption algorithms can be embedded to reduce or prevent unauthorized duplication. The algorithms may include compression that may further reduce the size of the memory that is required and or increase the perceived data transfer rates to and or from the flash-based memory.

It is another object of utilizing flash-based memory for licensed movie products for the ability to store usage information regarding when and how often the movie is viewed. Using this type of technology it is possible to rent just one viewing of the movie, and the movie does not allow multiple viewings.

It is another object of utilizing flash-based memory for licensed movies for the ability to store one or multiple bookmarks on the memory. This will allow multiple people to stat and stop the movie at different locations. It will also allow people to store their favorite part of the movie into memory without having to search for the part at some future time.

It is another object of utilizing flash-based memory to provide the ability of a store to store, erase and re-stores movies. This will allow a rental company the ability to maximize desirable movies and minimize movies that are not often rented. Another aspect of this feature is the ability of the rental company to only store blank flash based memory modules or require the user to bring in their own blank flash based memory modules. When a customer requests a specific movie, the movie can be written onto the flash memory and provided to the user. Distributing movies in this manner will allow a nearly infinite amount of availability of any movie with no fixed stock that can become obsolete or require discounting.

It is still another object of utilizing flash based memory for licensed movie production to use flash memory modules that are not perfect. When flash memory is used for data storage, every bit of data must be correct for the program to operate, but when flash based memory is used for audio or video re-production one or more bad bits will still produce an acceptable movie and or sound with little or no perception that there is one or multiple bad bits of data. This provides an outlet for flash based memory devices that would have no value or be trashed.

It is another object of using flash drive memory for licensed productions with higher data transfer rates. A DVD has a data transfer rate of about 39 Mb per second. Currently flash based data transfer rates are less than the data transfer rates from a DVD, but with compression algorithms with currently available flash memory modules, or using multiple flash memory modules in parallel, higher data transfer rates are possible and will satisfy the demands for licensed movie reproductions.

It is still another object of using flash drive memory for licensed movies to provide an upgrade path to advancements in movie features and functions such as wide screen and high definition without the need to change movie playing products. The advancements in storing higher amounts of information on the flash drive can be accomplished without the need to replace the hardware, as required by DVD drives, by simply using flash based memory device, or by using the flash based memory device to upgrade the movie playing apparatus from a program installed on the flash based drive memory.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows various flash based memory devices that are currently available.

FIG. 2 shows a block diagram of the internal construction of a flash based memory module.

FIG. 3 shows a block diagram of a flash based memory module that can support the higher data transfer rates required to show a typical licensed movie.

FIG. 4 shows a custom play and or recording module configured to operate with a TV.

### DETAILED DESCRIPTION

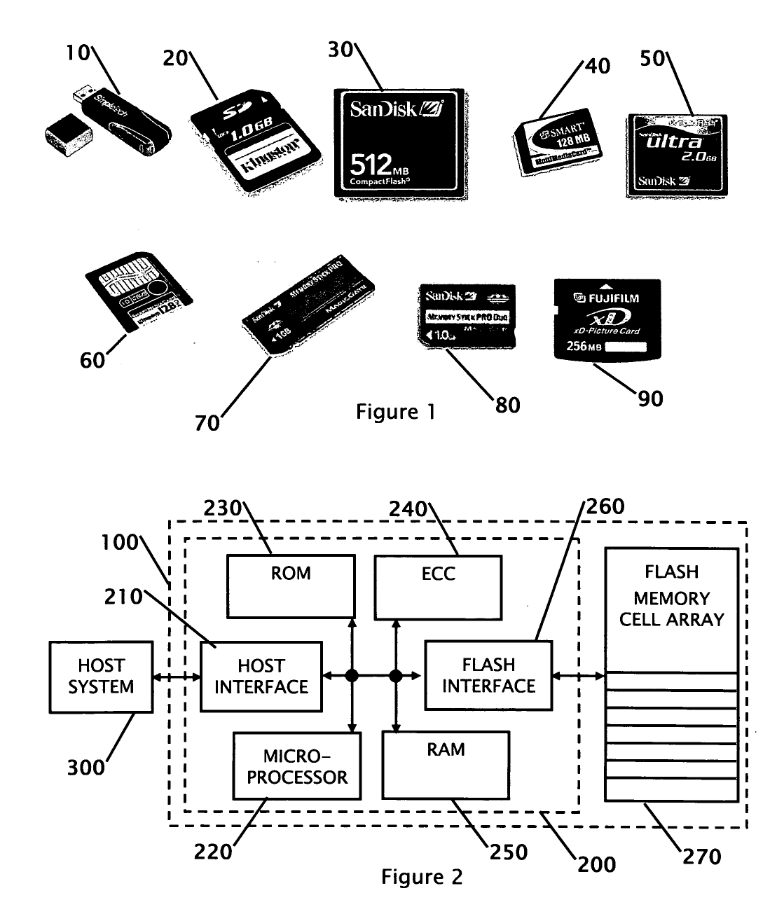

Referring to FIG. 1 that shows various flash based memory devices that are currently available. In this view, different styles of flash based memory modules are shown. From left to right these modules are identified as flash drive 1.0/1.1/2.0 10, Secure Digital (SD) card 20, Compact Flash (CF) 30, Multi Media Card (MMC) 40, Compact Flash 50, Smart Media 60, Memory Stick 70, SD 80 and xD-Picture Card 90. These flash memory modules are manufactured or sold by companies such as lomega, Transcend, Fuji, ScanDisk, SimpleTech, Verbatim, Mushkin, and PNY represent the devices that are currently available as well as others. These physical shapes of flash based memory modules represent configurations that are currently available, but other configuration can be utilized that will satisfy the requirement of storing and displaying licensed movie and TV productions. One embodiment of the block diagram for the construction of the flash based memory is shown in FIG. 2.

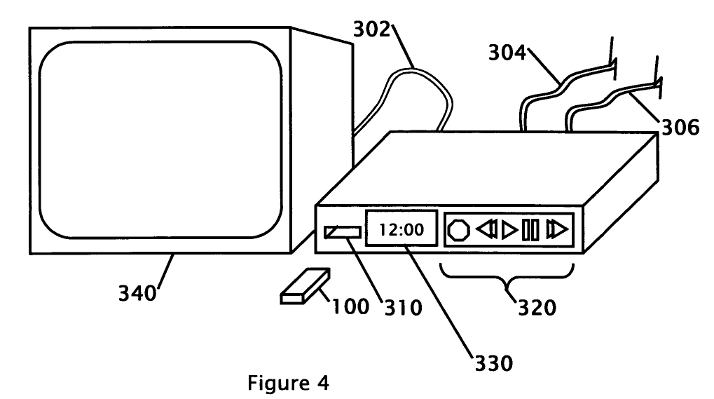

FIG. 2 shows a block diagram of the internal construction of a flash based memory module 100. The flash memory device is used with a host interface 300 of some type. One particular host system is shown and described in FIG. 4. The module can be encased in the enclosures shown and described in FIG. 1 above or in some other configuration that provides interface to store and play licensed movie or TV productions. The control portion of the flash module 200 handles the interface between the host system 300 and the Flash memory cell array 270. The flash interface 260 takes care of the data being written into and read from the Flash memory array. The flash memory module 270 comprises an array of flash memory cells. In the embodiment shown in this figure, only one block of flash memory is used. One limitation with the flash memory cells is the rate that data can be written to and read from an individual memory array. This limitation usually limits the ability to use current technology flash memory modules. Using a single flash memory array, the data save and recall rate approximates 5 to 10 Mbps. When flash was first used in computers, the computers used USB 1.0 interface that had a low and high data transfer rates of 1.5 Mbps and 12 Mbps. The initial Flash memory devices utilized the USB 1.0 and the latter USB 1.1 to transfer data into and out of the Flash devices. When USB technology became more standard, limitation of high data transfer rate from some CD, DVD and hard drive devices made it difficult to utilize the USB port. Because of the limitation for data transfer rates USB 2.0 was introduced that provided faster data transfer rate with a theoretical high data transfer rate of 480 Mbps.

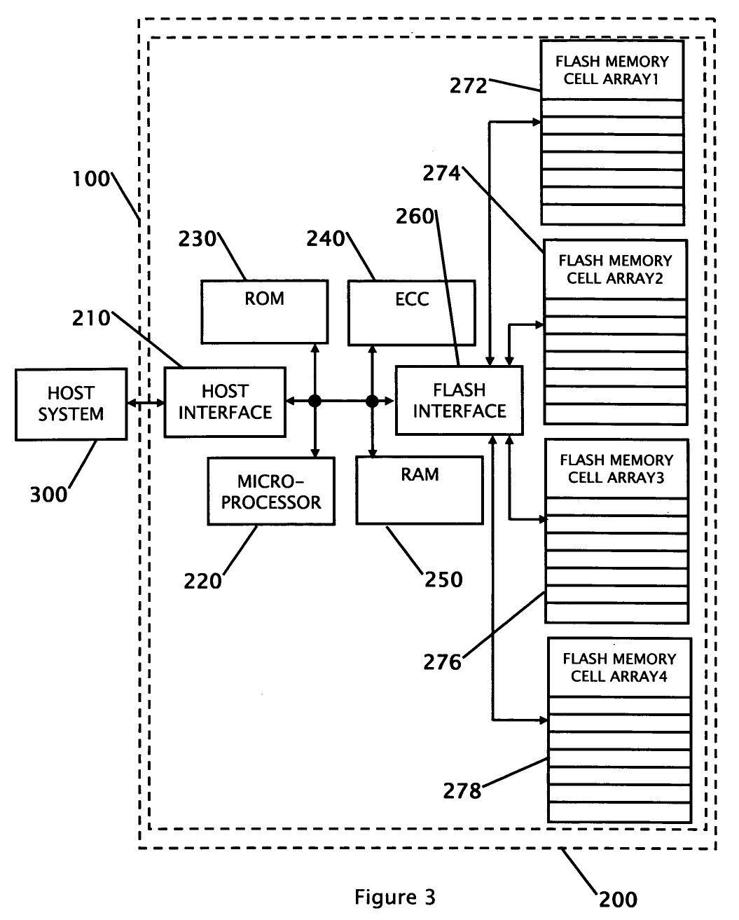

The flash memory device includes an interface block 210 that handles the connection, disconnection and interface with the host system 300. A common data buss connects the host interface to the microprocessor 220. The microprocessor 220 operates with the program in ROM 230. RAM 250 located in the Flash memory is used for temporary data storage that is not retained when power is no longer supplied to the memory module. The ECC circuit block 240 is a circuit that detects and corrects errors, to improve the accuracy of the data stored in the corresponding flash memory 270. In order to handle the faster data transfer rate required to show licensed theatrical and TV productions the data read rates to the memory array must be increased a minimum of four times. Another method of increasing the data transfer rate is to provide multiple Flash memory cell arrays as shown and described in FIG. 3.

FIG. 3 shows a block diagram of a flash based memory module that can support the higher data transfer rates required to show a typical licensed movie. This embodiment is similar to the Flash memory device shown in the block diagram in FIG. 2 with the exception that four flash memory cell arrays are being used. The use of the four memory modules increases the data transfer rate from about 10 Mbps to about 40 Mbps. This is sufficient to satisfy data transfer rates required equivalent to a DVD disk. The block diagram from FIG. 3 comprises the Flash memory device 100. The flash memory device is used in a host interface 300 of some type. One particular host system is shown and described in FIG. 4. The module can be encased in the enclosures shown and described in FIG. 1 above or in some other configuration that provides interface to store and play licensed movie or TV productions. The control portion of the flash module 200 handles the interface between the host system 300 and the Flash memory cell array 270. The flash interface 260 takes care of the data being written into and read from the Flash memory array. The flash memory module 270 comprises arrays of flash memory cells. The configuration of four memory modules is shown in this embodiment, but configurations with any number of Flash memory cell arrays are contemplated including but not limited to eight, 64, 256 or more Flash memory cell arrays. If 256 flash memory cells arrays are used, a 120 minute movie could theoretically be stored on the Flash memory device in just under two minutes. The flash memory device includes an interface block 210 that handles the connection, disconnection and interface with the host system 300. A common data buss connects the host interface to the microprocessor 220. The microprocessor 220 operates with the program in ROM 230. RAM 250 located in the Flash memory is used for temporary data storage that is not retained when power is no longer supplied to the memory module. The RAM memory can be used to temporally store data to and from each of the Flash memory arrays such that it is available for faster data transfer. The ECC circuit block 240 is a circuit that detects and correcting errors, to improve the accuracy of the data stored in the corresponding flash memory 270.

FIG. 4 shows a custom play and or recording device designed or configured to operate with a TV. This configuration is similar to configurations that could be found as a DVD and or video players. While the internal components are not shown in this figure, the host system 300 reads the data from the Flash memory device 100 and converts the data into a video signal. The data stored on the Flash memory module 100 is similar to the data stored on a DVD disk or VCR, and the conversion of the data from a DVD into a video signal is similar in nature. When the flash memory device 100 is placed into the socket, reader slot or connector 310 the device becomes available for transfer of the stored data or for recording information. Controls 320 allow the information to be played, stopped, fast-forwarded, rewound or recorded. A display 330 shows information such as but not limited to play time, record time, time of day, bookmark indicator, chapter or other counters. Connections for the flash memory play device may include but not be limited to a power connection 306 for powering the device, but power may also be provided by batteries, an antenna connection 304 or other similar input signal for receiving a signal that can be recorded, and connection 302 to the TV or monitor 340 for showing the licensed movie or TV production.

The use of flash based memory with the playing device provides many advantages over VHS and DVD devices. The flash based memory requires no mechanical drive mechanism to transport or move the media while it is playing. Encryption can be placed onto the media to prevent or reduce the possibility of duplication of the data on the flash memory. A rental or sales store might only keep an inventory of blank flash memory device, with a storage of every movie or TV show ever made, and could record the movie or TV show onto the flash based memory device on demand, and if the movie wrong, the flash based memory could be re-programmed without destroying or throwing away anything. In theory and entire video rental store could be reduced to flash memory devices and a computer with a large enough hard drive to store all the movies, or an Internet connection to download the desired movie. The flash memory device could be programmed with a counter to allow showing the movie a finite number of times or the movie erases itself. Because the flash memory device has recordable memory, one or multiple users could set book marks or place markers at different places in the movie to allow the movie, to be started or stopped at a particular point(s) without having to start the movie from the beginning.

It is further contemplated that a user could bring their own flash based memory device, into a video rental or mail order movie rental business, a movie could be stored on the flash memory for a single viewing and rented or sold to the user, thus further reducing the material stored at the rental store.

Today CDs are available for music or music and data. The difference between these two discs is that the CD's for music are not perfect, and may contain one or more errors that would be catastrophic if data is stored, but would cause little or no problem to record or play music. The same potential exists for using flash based memory devices that are not perfect where the storage of data would be catastrophic, but would cause little of no problem with showing a movie.

Today each DVD's is marked with a region code, and will only play in a DVD player from that region. A similar technology could be incorporated into Flash based movie storage such that a Flash memory stored movie from the USA will not play in an Australian player, and a Flash memory stored movie from Japan, Europe or Australia will not play in a USA player.

Copy protection and or write protection may be incorporated by selecting the protection from an option that is stored on the memory or by a mechanical means such as a switch, jumper or shunt.

Thus, specific embodiments and applications for using flash based memory devices for use with licensed movie or TV productions have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. The use of removable flash memory to store and distribute licensed movie and TV production comprising:
using a removable flash based memory device capable of storing and displaying a licensed movie or TV production,
converting or acquiring the licensed movie or TV production in a digital format that can be stored on the removable flash based memory device,
storing the licensed movie or TV production on the removable flash based memory device, and
the use and or distribution of the licensed movie or TV production for sales, rental or viewing from the removable flash based memory device.

2. The use of the removable flash memory to store and distribute licensed movie and or TV production from claim 1 that further includes a copy protection method or means to block duplication of the licensed movie and or TV production.

3. The use of the removable flash memory to store and distribute licensed movie and or TV production from claim 1 wherein the storing of the licensed movie or TV production is performed at the distribution source of the licensed movie company, TV production company, the rental company or other party licensed to copy the movie or production.

4. The use of the removable flash memory to store and distribute licensed movie and or TV production from claim 1 that further includes a feature to limit the number of times the licensed movie or TV production can be viewed.

5. The use of the removable flash memory to store and distribute licensed movie and or TV production from claim 1 that further includes the ability to bookmark one or more locations in the licensed movie or TV production for future reference and or continued viewing locations.

6. The use of the removable flash memory to store and distribute licensed movie and or TV production from claim 1 wherein the flash based memory device can be erased and or re-recorded.

7. The use of the removable flash memory to store and distribute licensed movie and or TV production from claim 1 that further includes a counter to accumulate the number of times and or the duration of time the removable flash memory has been viewed.

8. Using portable flash based memory device for storage and distribution of licensed theatrical video production comprising:
recording a licensed theatrical video production on a portable flash based memory device,
distributing the portable flash based memory device with the licensed theatrical video production for sale, rental or viewing.

9. The portable flash memory device to store and distribute licensed movie and or TV production from claim 8 that further includes a copy protection method or means to block duplication of the licensed theatrical video production.

10. The portable flash memory device to store and distribute licensed movie and or TV production from claim 8 wherein the storing of the licensed theatrical video production is performed at the distribution source of the licensed movie company, TV production company, the rental company or other party licensed to copy the movie or production.

11. The use of the removable flash memory device for storage and distribution of licensed theatrical video production from claim 8 that further includes a feature to limit the number of times the licensed movie or TV production can be viewed.

12. The portable flash memory device to store and distribute licensed movie and or TV production from claim 8 that further includes the ability to bookmark one or more locations in the licensed movie or TV production for future reference and or continued viewing locations.

13. The portable flash memory device to store and distribute licensed movie and or TV production from claim 8 wherein the flash based memory device can be erased and or re-recorded.

14. The portable flash memory device to store and distribute licensed movie and or TV production from claim 8 that further includes a counter to accumulate the number of times and or the amount of time the removable flash memory has been viewed.

15. A playing device for displaying licensed movie or TV production on a solid state memory device comprising:
providing a receiver for receiving a solid state memory device,
providing a solid state memory device capable of storing and transferring the data from the solid state memory device at a data transfer rate to show a licensed movie or TV production, and
converting the licensed movie or TV production from the solid state memory device to a video signal that can be shown on a TV or monitor.

16. The playing device for displaying licensed movie or TV production on a solid state memory device from claim 1 5 that further includes an copy protection method or means to block duplication of the licensed theatrical video production.

17. The playing device for displaying licensed movie or TV production on a solid state memory device from claim 15 wherein the storing of the licensed theatrical video production is performed at the distribution source of the licensed movie company, TV production company, the rental company or another party licensed to copy the movie or production.

18. The playing device for displaying licensed movie or TV production on a solid state memory device from claim 15 that further includes a feature to limit the number of times the licensed movie or TV production can be viewed.

19. The playing device for displaying licensed movie or TV production on a solid state memory device from claim 15 that further includes the ability to bookmark one or more locations in the licensed movie or TV production for future reference and or continued viewing locations.

20. The playing device for displaying licensed movie or TV production on a solid state memory device from claim 15 wherein the flash based memory device can be erased and or re-recorded.

21. The playing device for displaying licensed movie or TV production on a solid state memory device from claim 15 that further includes a counter to accumulate the number of times and or the duration of time the removable flash memory has been viewed.
